(19) United States
(12) Patent Application Publication
(10) Pub. No.: US 2004/0268351 A1
(43) Pub. Date: Dec. 30, 2004

(54) Scheduling with blind signaling

(75) Inventors: Preben Mogensen, Gistrup (DK); Troels B. Sorensen, Aalborg (DK)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 10/655,252

(22) Filed: Sep. 5, 2003

(30) Foreign Application Priority Data
Jun. 27, 2003 (EP) 03014731.8

(51) Int. Cl. G06F 9/46

(52) U.S. Cl. 718/100

(57) ABSTRACT

A scheduling method and device for scheduling data transmission, usually over a plurality of channels in a data network, wherein a utilization of an allocated maximum channel capacity in a received data stream of at least one of the plurality of channels is typically monitored, and future allocation of the maximum channel capacity is then normally controlled in response to the monitoring result. Thereby, data transmissions may be scheduled according to their often near instantaneous transmission capacity requirements, usually without requiring any explicit uplink signaling.

### BACKGROUND OF THE INVENTION

1. Field of the Invention

The present application relates generally to a scheduling device and/or method of scheduling data transmission, usually over a plurality of channels in a data network such as, but not limited to, a radio access network of a 3_{rd} generation mobile communication system.

2. Description of the Related Art

Achieving fair bandwidth allocation is typically an important goal for future wireless networks and has generally been a topic of intense recent research. In particular, especially in error-prone wireless links, it is usually impractical to guarantee identical throughputs to each user. As channel conditions vary, lagging flows may catch up to re-normalize each flow's cumulative service. Under a normal realistic continuous channel module, any user can usually transmit at any time, yet users will often attain different performance levels, for example, throughput, and/or require different system resources, depending on their current channel condition. Several scheduling algorithms have been designed for continuous channels that provide temporal and/or throughput fairness guarantees.

A common general assumption of existing designs is that only a single user may access the channel at a given time, in other words, time division multiple access (TDMA). However, spread spectrum techniques are increasingly being deployed, commonly to allow multiple data users to transmit simultaneously on a relatively small number of separate high-rate channels. In certain instances, multiple near-orthogonal or orthogonal channels may be created, typically via different frequency-hopping patterns or via spreading codes in Code Division Multiple Access (CDMA) systems.

Changing channel conditions are usually related to at least one of the three following basic phenomena: fast fading, typically on the order of milliseconds, shadow fading, typically on the order of tens of hundreds of milliseconds, and long-time-scale variations due to user mobility.

According to a study item in the Release 6 specification of the Universal Mobile Telecommunications System (UMTS), an enhanced uplink dedicated channel (EUDCH) with higher data rates is being developed for packet data traffic. The enhancements are generally approached by distributing some of the packet scheduler functionality to the base station devices, or Nodes B in the 3^{rd} generation terminology, to have faster scheduling of bursty, non real-time traffic than the conventional Layer 3 (L3) Radio Resource Control (RRC) at the Radio Network Controller (RNC). The idea is generally that, with faster scheduling, it is typically possible to more efficiently share the uplink power resource between packet data users. That is, when packets have been transmitted from one user, the scheduled resource may be made available immediately for another user. This tends to avoid the peaked variability of noise rise, especially when high data rates are being allocated to users running bursty high data rate applications.

In the current architecture, the packet scheduler is normally located in the RNC and, therefore, is typically limited in its ability to adapt to the instantaneous traffic due to the bandwidth constraints on the RRC signaling interface between the RNC and the terminal device, or user equipment (UE) in the 3^{rd} generation terminology. Hence, at least to accommodate the variability, the packet scheduler is normally and, in some cases, must be conservative in allocating uplink power to take into account the influence of inactive users in the following scheduling period. However, this solution commonly turns out to be spectrally inefficient for high allocated data rates and/or long release timer values.

For transmission of data, the UE frequently selects a transport format combination (TFC) that suits the amount of data to be transmitted in its Radio Link Control (RLC) buffer, usually subject to constraints on the maximum transmission power of the UE and the maximum allowed TFC. Primarily, the latter is commonly the output of the centralized packet scheduler. The UE may typically use any TFC, usually up to the maximum allowed, and, hence, this parameter is routinely used as a control variable by which centralized scheduling often exerts control on the packet data users.

81 For the implementation of fast centralized scheduling, it is usually required to have an equally fast uplink (UL) handshake mechanism between the UE and the Node B to inform about the instantaneous transmission requirements. However, such signaling information takes up resources, for example, bandwidth, of the physical layer and usually leaves less resources for actual data transmission.

### SUMMARY OF THE INVENTION

It is therefore an object of certain embodiments of the present invention to provide a scheduling mechanism by means of which explicit signaling between the centralized scheduling functionality and the scheduled data source may be avoided.

This object is commonly achieved by a scheduling device for scheduling data transmission over a plurality of channels in a data network, the device typically including monitoring means, usually for monitoring utilization of an allocated maximum channel capacity in a received data stream of at least one of the plurality of channels, and a scheduling means, normally for controlling allocation of the maximum channel capacity to the at least one of the plurality of channels, commonly in response to the monitoring means.

Furthermore, the above object is often achieved by a scheduling method of scheduling data transmission over a plurality of channels in a data network, the method commonly including the steps of monitoring utilization of an allocated maximum channel capacity in a received data stream of at least one of the plurality of channels, and controlling allocation of the maximum channel capacity to the at least one of the plurality of channels, typically in response to the result of the monitoring step.

Accordingly, the scheduling functionality and/or mechanism allocated, for example, at the Node B, usually monitors capacity utilization of the scheduled data sources, often based on the received data stream of their channels, and/or grants resources according to this utilization. Thereby, an explicit capacity request signaling from the data source to the scheduling functionality may be avoided and/or physical layer resources may be increased for improved data transmission. The scheduling mechanism routinely captures, usually through the monitoring means, the effect of a UE having to lower its data transmission rate, generally due to insufficient transmission power, in other words, the TFC elimination algorithm in the UE.

Furthermore, the scheduling mechanism commonly provides an error recovery in that it usually inherently monitors the allocated rate. In some instances, if the UE, due to transmission errors, interprets the allocated rate as being higher than what was actually allocated, this will often become apparent by the monitoring means. Using a feedback mechanism, the scheduling mechanism can generally keep track of its allocations.

The maximum channel capacity may correspond to a maximum allowed data rate. According to certain embodiments, the maximum allowed data rate may be set by a maximum transport format combination. This transport format combination is typically defined as the combination of currently valid transport formats on all transport channels of a mobile terminal or user equipment, in other words, commonly containing one transport format from each transport channel. The transport format is normally defined as a format offered by the physical protocol layer L1 to the Medium Access Control (MAC) protocol, usually for the delivery of a transport block set during a transmission time interval (TTI) on a transport channel. The transport format generally includes a dynamic part and a semi-static part. The transport block set is typically defined as a set of transport blocks passed to L1 from MAC normally at the same time instance using the same transport channel. A generally analogous and sometimes equivalent term for transport block set is MAC packet data unit (PDU) set.

The monitoring means may be configured to derive the maximum transport format combination, commonly by decoding a transport format combination indicator (TFCI) information provided in the received data stream. The TFCI information is normally a representation of the current transport format combination.

Furthermore, the monitoring means may be configured to perform the monitoring for a predetermined time period and/or to determine the number of transmission time intervals during which the maximum channel capacity is used in the received data stream. This transmission time interval may be defined, for example, as the inter-arrival time of transport block sets, in other words, the time it should typically take to transmit a transport block set. According to certain embodiments, the scheduling means may be configured to increase the maximum channel capacity, especially if the number of transmission time intervals determined by the monitoring means exceeds a predetermined number, and to decrease the maximum channel capacity, especially if that same number of transmission time intervals does not exceed the predetermined number. According to certain embodiments, the predetermined time period may correspond to eight transmission time intervals.

The plurality of channels may be dedicated uplink channels of a radio access network such as, but not limited to, the UMTS Terrestrial Radio Access Network (UTRAN). Then, the scheduling device may be a base station device, for example, a Node B, or a radio network controller device, for example, an RNC.

### BRIEF DESCRIPTION OF THE DRAWINGS

In the following, certain embodiments of the present invention will be described with reference to the accompanying drawings in which:

FIG. 1 shows a schematic diagram of an exemplary network architecture in which certain embodiments of the present invention may be implemented;

FIG. 2 shows a schematic diagram of a representative physical channel structure for a data transmission in which certain embodiments of the present invention may be applied;

FIG. 3 shows a diagram indicating typical a bit rate over time and a principle operation of blind data rate signaling according to certain embodiments of the present invention;

FIG. 4 shows a schematic block diagram of an exemplary scheduling functionality according to certain embodiments of the present invention; and

FIG. 5 shows a schematic flow diagram of a representative scheduling procedure according to certain embodiments of the present invention.

### DETAILED DESCRIPTION OF THE PREFERRED EMBODIMENT(S)

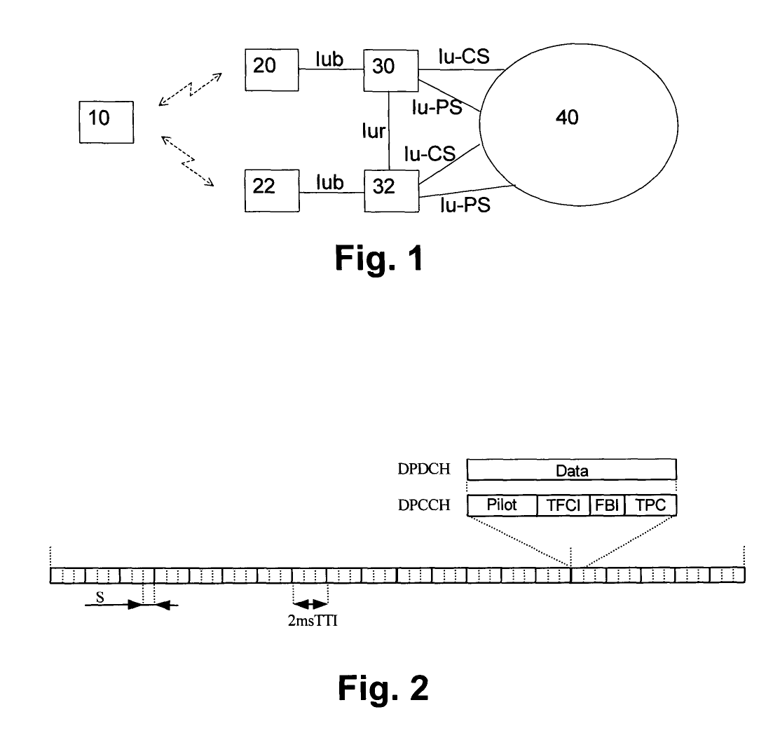

Certain embodiments of the present invention will now be described, typically on the basis of a 3^{rd} generation Wideband CDMA (WCDMA) radio access network architecture, as shown generally in FIG. 1.

₃^{rd} generation mobile systems like, for example, UMTS, are commonly designed to provide a wide range of services and/or applications to the mobile user. The support of higher user bit rates is most likely the best known feature of UMTS. Furthermore, provisioning of appropriate quality of service (QoS) will most likely be one of the key success factors for UMTS. A mobile user normally gets access to UMTS through the WCDMA-based UTRAN. A base station or Node B 20, 22 usually terminates the L1 air interface and typically forwards the uplink traffic from a UE 10 to an RNC 30, 32. The RNCs 30, 32 are generally responsible for radio resource management (RRM) and/or often control all radio resources within their part of the UTRAN. The RNCs 30, 32 are commonly at least some of the key interface partners for the UE10 and generally constitute the interface entity towards a core network 40, for example, via a UMTS Mobile Switching Center or a Serving GPRS (General Packet Radio Services) Support Node (SGSN). Within the UTRAN, Asynchronous Transfer Mode (ATM) is typically used as the main transport technology for terrestrial interconnection of the UTRAN nodes, in other words, RNCs and Nodes B.

In the representative simplified sample architecture shown in FIG. 1, the UE 10 is often connected via an air interface to a first Node B 20 and/or a second Node B 22. The first and second Nodes B 20, 22 are commonly connected via respective Iub interfaces, typically to first and/or second RNCs 30, 32 which are normally connected to each other via a Iur interface. The Nodes B 20, 22 are generally logical nodes responsible for radio transmission and/or reception in one or more cells to/from the UE 10 and routinely terminate the Iub interface towards the respective RNC 30, 32. The RNCs 30, 32 usually provide connections to the core network 40, normally for circuit switched traffic via a Iu-CS interface and/or for packet switched traffic via a Iu-PS interface. According to certain embodiments, many Nodes B are connected to the same RNC.

FIG. 2 shows a schematic diagram of an exemplary physical channel structure for one representative dedicated physical data channel (DPDCH). In the WCDMA system, each normal radio frame, the length of which is usually 10 ms, normally includes 15 slots S. In the uplink direction, the data and/or control part are normally IQ-multiplex, in other words, the user data of the DPDCH is commonly transmitted using the I-branch and/or the control data of the dedicated physical control channel (DPCCH) is generally transmitted using the Q-branch. Both branches are typically BPSK (Binary Phase Shift Keying) modulated. FIG. 2 shows both DPDCH and DPCCH in parallel. Each DPCCH slot usually includes two Transport Format Combination Indicator (TFCI) bits which, together with TFCI bits from other slots of the frame, commonly represent the current transport format combination, in other words, the combination of currently valid transport formats on all transport channels of the concerned UE 10. According to certain embodiments, the transport format combination includes one transport format for each transport channel. Furthermore, each DPCCH time slot of the frame structure of the time multiplexed transmission signal between the UE 10 and the Nodes B 20, 22 commonly includes a transmit power control command (TPC) field, typically used for a power control function as well as a pilot field, generally for signaling a pilot information. Moreover, a feedback information (FBI) field is often provided for feedback signaling. The uplink DPDCH field usually only contains data bits, typically from many transport channels. Further details concerning this representative WCDMA frame structure are described in the ₃^{rd} Generation Partnership Project (3GPP) specifications TS 25.211 and TS 25.212.

Furthermore, according to the exemplary structure of FIG. 2, each transmission time interval (TTI) which commonly defines the transmission time for a transport block set typically has a length of, for example, 2 ms, and thus generally corresponds to three time slots S. This shorter TTI is routinely used for the enhanced uplink dedicated channel (EUDCH), usually for increased cell and/or user throughput and/or shorter delay. Such a shorter TTI may be introduced, for example, by having it on a separate code channel, in other words, by code multiplexing it, or by, for example, incorporating it into the conventional time multiplexing scheme at radio frame level. The scheduling mechanism is not necessarily tied to a 2 ms TTI, and any other TTI value may therefore be used.

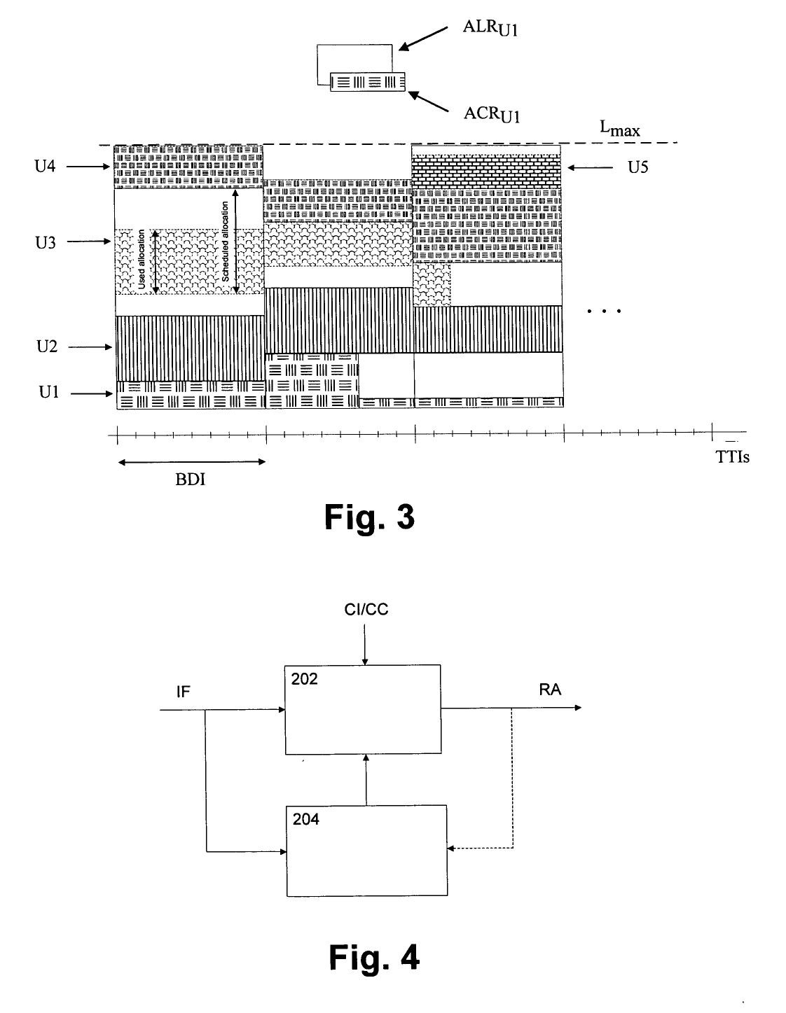

FIG. 3 shows a schematic diagram of data rate versus time indicating representative actual and allocated rates of five users U1 to U5 sharing respective transmission channels. In particular, FIG. 3 shows the typical allocated bit rate ALR as a white box and the representative actually used bit rate ACR as a shaded box inside the white box. The horizontal time axis is shown in units of TTIs.

According to certain embodiments of the present invention, a blind detection, in other words, a detection generally without control or handshake signaling, of data rate requirements and/or capacity requirements is usually performed based on a predetermined observation period, in other words, a blind detection interval BDI as indicated in FIG. 3. According to certain embodiments, the BDI may have a length of 8 TTIs. Of course, any other suitable length of the BDI may be selected.

The BDI is generally used to establish and/or determine whether a currently granted bit rate allocation needs upgrading and/or downgrading of the maximum allowed bit rate, for example, TFC value. Hence, the BDI typically determines the response time for a change in resource usage. In the example of FIG. 3, the respective scheduler or scheduling function normally allocates available resources, in other words, bit rates, up to, for example, a constant load limit Lₘₐₓ.

The pattern of the shaded boxes usually indicates the individual user which transmits the respective data stream. During the first BDI on the left side of the diagram of FIG. 3, the users U2 and U3 do not commonly fully utilize their allocated maximum capacity and/or maximum bit rate, generally due to the fact that the shaded box indicating their used capacity allocation is commonly smaller than the white box typically indicating the scheduled maximum capacity allocation. In this respect, as indicated in the upper portion of FIG. 3, the white box and shaded box are normally shown in an overlapped manner, so that the allocated maximum bit rate is usually fully utilized if no remaining part of the white block is shown above the shaded block. Accordingly, during the second BDI of FIG. 3, the users U2 and U4 generally do not fully use their scheduled capacity allocation, while the user U1 initially, for example, for the first five TTIs, normally fully utilizes its allocated maximum bit rate and then, for the remaining TTIs, usually only uses a small portion of its allocated maximum bit rate. Then, in the third BDI shown on in the right portion of FIG. 3, a new, fifth user U5 often shares the channel capacity, but does not generally fully utilize its allocated maximum capacity and/or bit rate. The user U1 commonly maintains its small utilization for the whole BDI while the user U3 normally initially utilizes its allocated maximum bit rate to a full extend, usually until the beginning of the third TTI, and then does not normally transmit any data for the remaining six TTIs.

The allocation of the available resources by the scheduling device, which may be, for example, the respective Node B, is often based on the above-described utilization of the maximum allocated capacity or bit rate. This means, at least in some instances, that the difference between the used capacity allocation and the scheduled capacity allocation is normally decisive for the future scheduled capacity allocation. Thereby, high variability of uplink noise rise may be avoided, for example, by scheduling UE transmissions according to their near instantaneous transmission capacity requirements and correspondence between allocated and actually required uplink resources may thereby usually be achieved, commonly without any explicit uplink signaling requirements. Therefore, the term “blind signaling” is generally used. This correspondence between allocated and used capacity is also typically advantageous for cell capacity, as it usually helps to free the maximum amount of resources packet data use.

According to certain embodiments, the Nodes B 20, 22 continuously monitor the utilization of the UE's currently allocated maximum TFC, which is typically known to the Nodes B 20, 22, for example, from decoding the TFCI information in the uplink data frames. Based on the monitored utilization, the scheduling function at the Nodes B 20, 22 normally grants resources, in other words, usually allocates a new maximum TFC. If the utilization is high, in other words, a large fraction of frames uses the maximum TFC, the Nodes B 20, 22 may schedule the respective user for a higher maximum TFC, whereas a low utilization may result in a lower scheduled maximum TFC. This may also be seen in FIG. 3, where the user U4 which has typically fully utilized its scheduled maximum bit rate in the first BDI has obtained a higher maximum bit rate in the second BDI. On the other hand, the user U3 which generally has not fully utilized its maximum bit rate, has usually been scheduled to a lower maximum bit rate during the second BDI. For the user U2, the maximum bit rate has normally remained, while it has also commonly increased for the user U1. In the third BDI of FIG. 3, the maximum bit rate of the user U2 has decreased, while it has remained for the other users U1, U3 and U4. The non-used and/or freed capacity has then been allocated to the new fifth user U5.

However, the exact action taken by the scheduling function may depend on other parameters such as, but not limited to, the scheduling policy, the current cell load, QoS descriptive parameters such as, but not limited to, an Allocation Retention Priority (ARP) for the user, the traffic class (TC), and the traffic handling priority (THP). Furthermore, the scheduling decision may depend on, for example, minimum and/or maximum data rate allocations and/or uplink radio link conditions, for example, estimated path loss, such that higher maximum TFC is commonly scheduled only when the channel conditions are favorable to thereby usually avoid unnecessary retransmissions and/or to generally provide better power efficiency of the UE. The use of such additional information in scheduling may include, for example, the downlink (DL) power control (PC) commands, since they usually indicate whether channel quality improves or degrades.

For simplification, all other issues impacting the granted maximum TFC are disregarded in the following description, and the scheduling decision is assumed to be based only on the utilization factor of the currently allocated maximum TFC. Hence, the granted maximum TFC is usually adapted to the individual capacity demand of the UE10.

FIG. 4 shows a schematic block diagram of a scheduling functionality which may be implemented at each of the Nodes B 20, 22 in FIG. 1. A scheduling decision making block or scheduling block 202 typically makes scheduling decisions based at least on the utilization factor of the currently allocated maximum TFC which is routinely monitored by a corresponding utilization monitoring block 204. Additionally, the scheduling decision may be based on other general channel information CI and/or channel conditions CC which, however, are omitted from the description of the embodiment described below, as already mentioned above.

The scheduling block 202 generally receives an incoming data stream and/or data flow IF and/or outputs a corresponding scheduling decision and/or resource allocation RA, which may represent, for example, a set of maximum data rates and/or maximum TFCs for simultaneous transmission of multiple users. This scheduling decision is usually output to the physical layer, which normally transmits packets accordingly. This may be achieved by some kind of explicit signaling, for example, by defining a new signaling channel, stealing bits by puncturing, and/or any other suitable signaling option.

However, adapting to the individual utilization may lead to short-term deviations from ideal fairness. Therefore, to enable service compensation at a later and/or more opportune time to underserviced flows, the scheduling decision may, optionally, be fed back to the utilization monitoring block 204, as indicated by the dotted arrow in FIG. 4. Then, the utilization monitoring block 204 may update its output values in such a manner that the output of the scheduling block 202 will generally satisfy the fairness criteria on a larger time scale. As an alternative, this long-term fairness control may be implemented in the scheduling block 202 itself.

The scheduling and/or utilization monitoring blocks 202 and 204 may be implemented, for example, as concrete hardware structures or, in the alternative, as software routines controlling a corresponding processing unit, for example, for MAC layer processing at the Nodes B 20, 22.

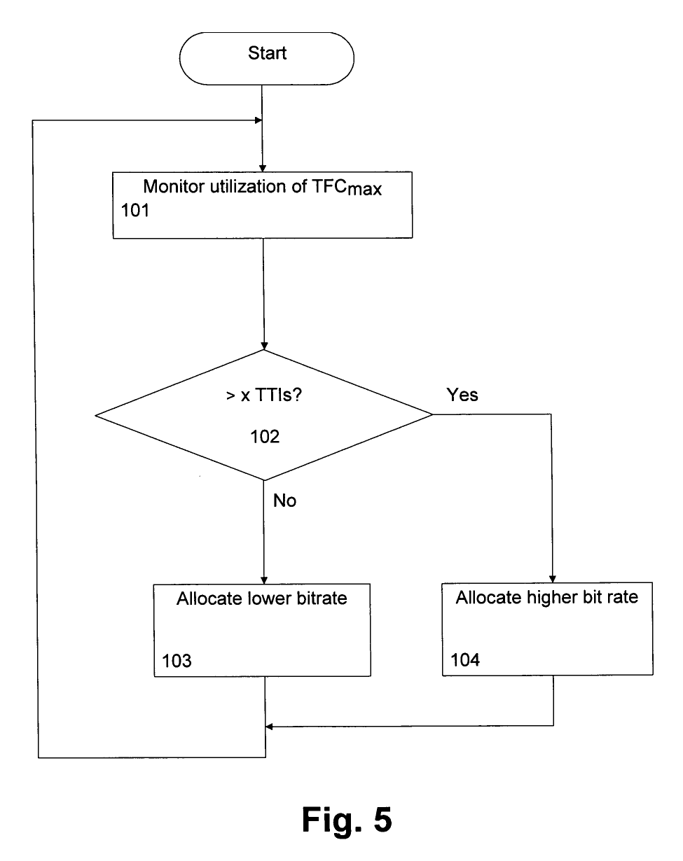

FIG. 5 shows a schematic flow diagram of a specific example of a scheduling procedure according to certain embodiments of the present invention. Initially, in step 101, the utilization of the maximum TFC is usually monitored during the BDI, for example, by comparing the actual data rate ACR of a user to the allocated data rate ALR of this user. Then, in step 102, the number of TTIs during which the maximum bit rate or TFC has been utilized is normally determined and/or compared to a predetermined threshold value x. If more than x out of y recent TTIs have used the maximum currently allocated TFC, then the procedure generally proceeds to step 104, and the scheduling block 202 of FIG. 4 routinely issues a scheduling decision to trigger an “up” request, in other words, to allocate a higher maximum bit rate and/or TFC. On the other hand, if it is determined, usually in step 102, that the respective UE has used in less than or at least in x out of y recent TTIs, the maximum currently allocated TFC or bit rate, then a scheduling decision is typically issued which triggers a “down” request, in other words, allocates a lower maximum bit rate or TFC (step 103). Then, the procedure may loop back to step 101 so as to continuously adapt the scheduled maximum capacity to the capacity demand of the respective user or UE.

As already mentioned, the scheduling functionality according to the embodiments illustrated in FIGS. 4 and 5 may be implemented in the MAC layer functionality of the Nodes B 20, 22. There may be other factors as well, which be useful in determining the maximum TFC that the scheduling functionality at the Nodes B 20, 22 grants to a certain UE.

Thus, an enhanced uplink channel packet scheduling may be provided, especially where the scheduling device makes scheduling decisions without explicit uplink signaling, such as rate requests. This often provides the advantage that less signaling overhead is required in the uplink direction.

It is to be noted that the present invention is not restricted to the above-discussed embodiment, but can be implemented at least in any multi-channel data transmission to thereby typically provide a capacity allocation with improved throughput and/or reduced signaling requirements. According to certain embodiments, the invention is not restricted to an uplink direction of a cellular network and may be implemented, for example, in any data transmission link. The channel capacity may be determined by other parameters such as, but not limited to, allocated maximum bandwidth in a frequency multiplexing system and/or allocated time period in a time multiplexing system. Thus, any parameter suitable to control an allocated channel capacity may be used. The embodiments of the present invention may thus vary within the scope of the attached claims.

One having ordinary skill in the art will readily understand that the invention, at least as discussed above, may be practiced with steps in a different order, and/or with hardware elements in configurations which are different than those which are disclosed. Therefore, although the invention has been described based upon the above-discussed embodiments, it would be apparent to those of skill in the art that certain modifications, variations, and/or alternative constructions also remain within the spirit and scope of the invention. In order to determine the metes and bounds of the invention, therefore, reference should be made to the appended claims.

We claim:

1. A scheduling device for scheduling data transmission over a plurality of channels in a data network, said device comprising
monitoring means for monitoring utilization of an allocated maximum channel capacity in a received data stream of at least one of said plurality of channels; and
scheduling means for controlling allocation of said maximum channel capacity to said at least one of said plurality of channels in response to said monitoring means.

2. The device according to claim 1, wherein said monitoring means monitors utilization of said maximum channel capacity and wherein said maximum channel capacity corresponds to a maximum allowed data rate.

3. The device according to claim 2, wherein said monitoring means monitors said maximum allowed data rate and wherein said maximum data rate is set by a maximum transport format combination.

4. The device according to claim 2, wherein said monitoring means is configured to derive said maximum transport format combination by decoding a transport format combination indication information provided in said received data stream.

5. The device according to claim 1, wherein said monitoring means is configured to perform said monitoring for a predetermined time period and to determine the number of transmission time intervals during which said maximum channel capacity is used in said received data stream.

6. The device according to claim 5, wherein said scheduling means is configured to increase said maximum channel capacity if said number of transmission time intervals determined by said monitoring means exceeds a predetermined number, and to decrease said maximum channel capacity if said number of transmission time intervals does not exceed said predetermined number.

7. The device according to claim 5, wherein said monitoring means is configured to perform said monitoring for said predetermined time period and wherein said predetermined time period corresponds to eight transmission time intervals.

8. The device according to claim 1, wherein said plurality of channels are dedicated uplink channels of a radio access network.

9. The device according to claim 1, wherein said scheduling device comprises a base station device.

10. A scheduling method of scheduling data transmission over a plurality of channels in a data network, said method comprising the steps of:
monitoring utilization of an allocated maximum channel capacity in a received data stream of at least one of said plurality of channels; and
controlling allocation of said maximum channel capacity to said at least one of said plurality of channels in response to the result of said monitoring step.

11. The method according to claim 10, wherein, in said monitoring step, said maximum channel capacity comprises a maximum allowed data rate.

12. The method according to claim 11, further comprising the step of setting said maximum allowed data rate by a maximum allowed transport format combination.

13. The method according to claim 12, wherein said monitoring step comprises the step of deriving said maximum transport format combination by decoding a transport format combination indication information provided in said received data stream.

14. The method according to claim 10, wherein said monitoring step is performed for a predetermined time period and comprises the step of determining the number of transmission time intervals during which said maximum channel capacity is used in said received data stream.

15. The method according to claim 14, wherein said controlling step comprises the steps of increasing said maximum channel capacity if said number of transmission time intervals determined in said monitoring step exceeds a predetermined number, and decreasing said maximum channel capacity if said determined number of transmission time intervals does not exceed said predetermined number.

16. The method according to claim 14, further comprising the step of setting said predetermined time period to a value comprising eight transmission time intervals.

17. A scheduling device for scheduling data transmission over a plurality of channels in a data network, said device comprising:
a utilization monitoring block for monitoring utilization of an allocated maximum channel capacity in a received data stream of at least one of said plurality of channels; and
a scheduling block for controlling allocation of said maximum channel capacity to said at least one of said plurality of channels in response to said utilization monitoring block.
